(19) United States
(12) Patent Application Publication
(10) Pub. No.: US 2023/0271516 A1
(43) Pub. Date: Aug. 31, 2023

(54) CHARGING CABLE

(71) Applicant: Robert Bosch GmbH, Stuttgart (DE)

(72) Inventors: Daniel Meyer, Stuttgart (DE); Markus Schreiber, Markgroeningen (DE); Martin Schmidt, Stuttgart (DE); Michael Loercher, Stuttgart (DE)

(21) Appl. No.: 18/006,522

(22) PCT Filed: Jul. 22, 2021
(86) PCT No.: PCT/EP2021/070538

§ 371 Date: Mar. 2, 2023

(30) Foreign Application Priority Data
Jul. 27, 2020 (DE) 10 2020 209 455.1
Apr. 1, 2021 (DE) 10 2021 203 363.6

(51) Int. Cl. B60L 53/18; B60L 53/16; B60L 53/12

(52) U.S. Cl. CPC B60L 53/18; B60L 53/16; B60L 53/12; B60L 2250/16

(57) ABSTRACT

A charging cable for electrical connection of an energy store of a vehicle to an energy supply unit. The charging cable includes a charging line including a coupling and as multiple conductors electrically connected to the coupling, a first connection device including an energy transfer arrangement for electrical connection to the energy store, a second connection device including a first connection for electrical connection to the energy supply unit and including a second connection for detachable electrical connection to the coupling, respectively one electrical conductor of the charging line being assigned to at least a portion of the energy transfer arrangement of the first connection device, the first connection device including a control unit, the first connection device or the charging line including a bypass switch, the bypass switch being switchable between a first switching state and a second switching state based on a type of the second connection device.

### FIELD

The present invention relates to a charging cable for charging a battery of a vehicle.

### BACKGROUND INFORMATION

Electric vehicles generally have an electrical energy store, for example, a traction battery, which provides the electrical power for the drive. If this electrical energy store is wholly or partially drained, the energy store of the electric vehicle must then be connected at a charging point to the mains power supply and be recharged.

There are currently various possibilities on the market for charging electric vehicles. For example, electric vehicles may be charged at publicly accessible charging poles or charging stations or in the private sector at a normal power outlet. Underlying the aforementioned here are two fundamental principles.

On the one hand, charging may take place at a permanently installed charging station (charging poles or so-called wallboxes). For this purpose, either a charging cable is plugged into the charging station or the charging cable is already fixedly connected to the charging station. Such a charging cable is also referred to as a passive charging cable. It is used merely to conduct the current from the charging station to the energy store situated in the vehicle. If the user intends to charge his/her energy store at such a charging station, he/she must first identify and authorize himself/herself. The identification takes place, for example, by reading in an RFID card, a credit card or via the connection to an app installed on the mobile phone of the requestor. The authorization also takes place with the aid of an app or via a piece of payment information stored on the RFID card. Finally, once identification and authorization are completed, the charging station takes control of switching on the charging current. The charging cable in this case has the sole function of establishing the electric connection to the electric vehicle—hence, the designation “passive charging cable.” The disadvantage of this is the complex process consisting of identification and authorization and switching on and off of the charge current by the charging pole; processes, which must be initiated by the driver or requestor.

On the other hand, charging may take place at so-called continuous current power outlets. For this purpose, a charging cable including an integrated control (ICCB: In-Cable-Control-Box) is required. The ICCB has the function of verifying via communication with the electric vehicle the charging readiness of the vehicle, of switching on the current when requested and of permanently monitoring the safe electrical connection to the electric vehicle and, of switching it off in the event of a malfunction. The disadvantage in this case is the control integrated in the charging cable, which results in a complex handling (boxes on the cable, colloquially: charging bricks) and also an increased pull on the plug of the charging cable.

Regardless of the respective charging methods—whether at the charging station or at continuous current power outlets—the driver expects on the one hand a rapid and, on the other hand, uncomplicated, simple charging process.

There is therefore a need to simplify for the driver or user of an electric vehicle the charging of his/her vehicle.

### SUMMARY

A charging cable according to the present invention allows, in particular, for the use of different energy supply units. Thus, for example, common household power outlets may be advantageously used, for example, via safety plug connectors or the respectively country-specific household plug connectors, which always provide a constant electric voltage or an electric continuous voltage. Specialized charging poles or so-called wallboxes, i.e., specialized charging infrastructures, may preferably also be used, which are specifically designed for charging the energy store of hybrid vehicles or electric vehicles. The term “vehicle” is understood to mean land-based vehicles, watercraft and also aircraft. The charging cable is thus on the one hand modularly usable, and on the other hand, the charging cable has a simple and compact design. The provision of an additional technical module, which is designed, for example, as a control box (the so-called ICCB) in charging cables from the related art and which lies, for example, on the ground during the charging process and may be damaged as a result, as well as making the charging cable cumbersome, difficult to store and heavy is, in particular, avoided.

The charging cable is suitable for electrical connection to an energy store to be charged of a hybrid vehicle or electric vehicle including an energy supply unit providing electrical power. The charging cable is designed or configured, in particular, to connect the energy store to the energy supply unit. The charging cable is further designed or configured, in particular, to establish, monitor, and control the connection of an energy store to an energy supply unit. According to an example embodiment of the present invention, the charging cable includes for this purpose a charging line, a first connection device and a second connection device. The charging line in turn includes a coupling as well as multiple electrical conductors electrically connected to the coupling for power transfer and/or signal transfer. The first connection device is used for electrical connection to the energy store and includes for this purpose energy transfer means (i.e., an energy transfer arrangement). The energy transfer means are preferably, for example, electrical contacts or induction coils. The energy transfer means are used for indirectly or directly detachable electrical connection to the energy store, the electrical connection being capable of being wireless (for example, inductive) or wired (for example, by lines). The second connection device includes a first connection and a second connection, the first connection being suitable or designed or configured for indirectly or directly detachable wireless or wired electrical connection to the energy supply unit. The second connection is used for detachable electrical connection to the coupling. Here, too, it is provided that the aforementioned electrical connection is designed to be indirectly or directly detachable. Here, too, the electrical connection is advantageously designed, for example, to be wireless and/or, for example, wired.

The second connection device and the charging line are—in other words—connected to one another in a detachable, i.e., non-destructively detachable, manner. Thus, the second connection device may be interchanged in order to be attached to different types of energy supply units and/or energy supply connections (for example, Type 1, Type 2, Type 3, CEE, CCS, CHAdeMo, Tesla connection, Type B, Type D, Type E, Type G, Type H, Type I, Type J, Type L, Schuko or the like). As described above, permanent voltage sources such as, for example, household power outlets, and specialized charging infrastructures such as, for example, charging poles or wallboxes, may equally be used with the charging cable.

According to an example embodiment of the present invention, respectively one electrical conductor of the charging line is assigned to at least a portion of the energy transfer means of the first connection device. Respectively one electrical conductor of the charging line is particularly preferably assigned to each of the energy transfer means. The first connection device further includes a control unit. In a first alternative, it includes a bypass switch. In an alternative design, the bypass switch is provided in the charging line, only one bypass switch being present. This means that the bypass switch is provided either in the first connection device or in the charging line. The bypass switch is switchable between a first switching state and a second switching state as a function of a type of the second connection device. This means, in particular, that a change of the switching state of the bypass switch is possible only through a change in the type of the second connection device. The switch-over of the bypass switch takes place advantageously by an alternation of the second connection device between a second connection device that is designed (in particular, without a control, for example, household power outlets) for an energy supply unit that has a constant electric voltage supply or electric constant voltage, for example, 230 V or 110 V, and a second connection device that is provided with a separate control for an energy supply unit (for example, wallboxes or charging poles). In other words: the bypass switch switches into the first switching state or into the second switching state depending on which type of second connection device is attached to the charging cable (via the coupling). In the first switching state, an electrical connection between at least one of the transfer means and the assigned electrical conductor is established by the bypass switch while bypassing the control unit. In the second switching state, the control unit is electrically interconnected between the at least one energy transfer means, which is connected in the first switching state via the bypass switch to the assigned electrical conductor and via the respectively assigned electrical conductor. This enables the control unit (in the second switching state) to control the current flow between the vehicle and the energy supply unit, in particular, to control the charging process.

The control unit is therefore used only when it is actually needed. Should the control unit not be needed, because a corresponding energy supply unit is used that necessitates no control unit at all, the bypass switch is then switched into the first switching state. This switching process takes place by using the corresponding second connection device for the corresponding energy supply unit. If, on the other hand, an energy supply unit is to be used that necessitates the presence of the control unit (for example, because no independent control or no independent communication with the vehicle to be charged is able to take place, for example, when using household power outlets), then the bypass switch is switched into the second switching state, which occurs in turn by using the corresponding second connection device adapted to the specific energy supply unit. An intervention by the user is unnecessary. Instead, the user is able to comfortably use the charging cable for different situations, the user having to give no thought at all to the cable being correctly configured. Instead, a complete design is provided according to the principle “plug and play,” which necessitates no interventions by the user at all. The user must only select the suitable second connection device for a given energy supply unit and connect it via the coupling to the charging line.

According to an example embodiment of the present invention, by providing the control unit in the first connection device, it is particularly advantageously possible to dispense with a complex, bulky and heavy charging box (ICCB) in the charging line, as a result of which the charging cable is advantageously less bulky, the control unit is better protected against destruction, the charging cable is easier to stow and to handle, and the weight is reduced. This also reduces the pull on the first or second connection device, thereby also avoiding damage to the first or second connection device and/or the counter-connection device. The decoupling of the second connection device from the counter-connection device or the energy supply unit is also avoided—for example, in the case of a power outlet mounted at a height of more than 1 m or at a height of more than 1.50 m, into which the second connection device is plugged and out of which power outlet the second connection device then falls, since the ICCB exerts too great a pull on the connection device. Moreover, the risk of tripping with the existing connection of vehicle and energy supply unit via the charging cable is significantly reduced, since an ICCB is no longer lying on the ground. The arrangement of the bypass switch in the first connection device yields the same results. If the bypass switch is situated in the charging line, then it is significantly smaller and lighter compared to a complete ICCB, thus also yielding the aforementioned advantages. The arrangement of the bypass switch in the charging line also allows for a more compact shape of the first connection device. On the whole, therefore, a charging cable is thus advantageously created, which is lighter in terms of weight, easier to handle and to stow, more flexible and durable and safer from damage, and which may also be more cost-efficiently manufactured, since a special protection against destruction of an ICCB lying on the ground may be dispensed with.

“Charging line” within the scope of the present invention is understood to mean, in particular, that multiple electrical conductors are combined. The electrical conductors are electrically insulated from one another, for example, in each case by a separate insulation sheath. All electrical conductors are also enclosed in a shared, electrically insulating main sheath. The main sheath serves preferably also to protect the electrical conductors from external influences, on the one hand, from environmental influences, on the other hand, from mechanical stresses.

It is understood that the bypass switch, if it is provided in the first connection device, may be a switch separate from the control unit. It may, for example, be designed as a discrete component or as an integrated component in semiconductor technology. It may also be provided, however, that the bypass switch is integrated into the control unit, in particular, designed as one piece or detachably not without being damaged with the control unit or in the control unit. It is also possible that the bypass switch is also designed in an ASIC, which constitutes the control unit. In the case of such an integration, the first switching state is understood functionally in such a way that the signals or the current between the at least one energy supply means of the first connection device and the respectively assigned electrical conductor, is/are bypassed with the aid of the bypass switch, for example, past signal processing components of the control unit. In other words, the elements of the control unit designed for a control (for example, ASICs, electronic components, etc.) are then not activated by the current flowing via the bypass switch. By integrating the bypass switch into the control unit in this way, it is possible to design the first connection device even more compactly and cost-efficiently.

Preferred refinements and example embodiments of the present invention are disclosed herein.

According to an example embodiment of the present invention, it is preferably provided that the charging line includes an additional coupling. The additional coupling serves to connect the first connection device to the charging line. In this case it is provided that for the purpose of power transfer and/or signal transfer, the electrical conductors extend continuously between the coupling and the additional coupling. The aforementioned electrical conductors are, in particular, not interrupted. Interruption in this specific case means that no further electrical components of any kind are interconnected between the coupling and the additional coupling. Instead, the electrical conductors extend, in particular, directly and uninterrupted from the coupling to the additional coupling, so that, for example, a continuous copper line per conductor is present. Thus, the charging line is preferably purely a connection element without any active or passive electronic components. The charging line is thus designed in a very simple and cost-efficient manner. Using the coupling and the additional coupling also makes it possible to replace the charging line in case of a defect, it not being necessary to simultaneously replace the first connection device and/or the second device. This is advantageous for users of the charging line, since they save significantly on costs if they are only required to substitute the beneficial charging line if the latter is damaged or is too heavily contaminated. Since the first connection device and/or the second connection device include(s) active and/or passive electronic components, it is thus possible to minimize the financial cost of the aforementioned replacement of the charging line. The first connection device advantageously includes an additional connection, which is electrically connectable to the additional coupling. In this way, an electrical connection of the energy transfer means and/or of the control unit and/or of the bypass switch to the electrical conductors of the charging line may be established. The electrical connection between the additional coupling of the charging line and the additional connection of the first connection device takes place, in particular, wirelessly or wired and is designed to be indirectly or directly detachable. The charging line and the first connection device are thus either connected to one another permanently and thus detachably not without being damaged or, alternatively, coupled separably to one another.

According to an example embodiment of the present invention, the first connection device preferably includes a first housing. Both the energy transfer means as well as the charging line are formed on the first housing. Alternatively, both the energy transfer means as well as the additional connection are formed on the first housing. Thus, the first connection device, as described above, is either connected directly and separably not without being damaged to the charging line or, alternatively, is detachably connectable to the charging line via the additional coupling and additional connection. Alternatively or in addition, the second connection device includes a second housing. Both the first connection and the second connection are formed in the second housing. Thus, the second connection device is an, in particular, one-piece body that includes a shared housing for all components present. The same applies to the first connection device, here the charging line being either permanently or detachably attached. It may be provided, in particular, that the counter-coupling piece suitable for coupling is connected directly to the housing or is provided or is situated in or on the housing.

According to an example embodiment of the present invention, it is advantageously also provided that the bypass switch is switched into the second switching state when a supply voltage is present and into the first switching state when a supply voltage is absent. Alternatively or in addition, the bypass switch is switchable by the control unit between the first switching state and the second switching state. Thus, the activation of the bypass switch is a function either of the presence of a supply voltage or of a signal of the control unit, a combination thereof also being possible. This supply voltage may be present or be provided or even also not be present or not be provided, for example, as a function of the type of the second connection device. Thus, the switching state of the bypass switch is a function of the type of the second connection device attached to the charging cable.

According to an example embodiment of the present invention, the second connection device particularly preferably includes a voltage supply. The voltage supply is electrically coupled to the first connection and provides an electric voltage supply when an electric voltage is present at the first connection. The electrical supply voltage is, in particular, a direct voltage, an alternating voltage also being possible. The direct voltage is particularly advantageously converted from an electrical alternating voltage provided by the energy supply unit. It is further preferably provided that the electrical supply voltage is provided for the purpose of switching over the bypass switch and/or to supply the control unit with electrical power. The electrical supply voltage may be particularly preferably applied at the bypass switch via the second connection and the charging line in order to switch the bypass switch into the second switching state. Thus, the switching of the bypass switch takes place as a function of the type of the second connection device in such a way that the second connection device does or does not generate the aforementioned supply voltage. In other words, the type of the second connection device differs, for example, in that the voltage supply is present. If a voltage supply is present, then the switching of the bypass switch into the second switching state takes place preferably due to the supply voltage. In this case, a charging of the energy store is particularly advantageously enabled based on a constant electrical voltage source or electrical continuous voltage source without a control line or communication line such as, for example, a household power outlet. In this case, a household power outlet is cited here merely as an example. In this second switching state, the control unit is activated in the first connection device. It is now able to take control of the communication with the vehicle or with its energy store and is itself able to actively control the current feed from the energy supply unit as a function of the charge requirement. This communication of the vehicle and the charging cable with the aid of the control unit may be important if the energy supply unit itself is not controllable or includes no signal line. The current feed must then be controlled via the charging cable or via the control unit.

If, on the other hand, no voltage supply is present in the second connection device, then the second connection device is used preferably and merely by way of example to connect a dedicated charging infrastructure as the energy supply unit. This usually includes at least one communication line, with the aid of which, the charge current, for example, may be actively controlled as a function of the needs of the energy store to be charged and/or of the capacity of the energy supply unit, for example, of the charge current. In this case, the bypass switch is switched over into the second switching state, as a result of which the control unit of the first connection device is not needed. The control unit is thus neither supplied with electrical power, nor interconnected into the electrical path between the energy supply unit and the energy store.

It is understood that, in principle, the second connection device may also provide a supply voltage and thus may activate the control unit when a second connection device, for example, for a wallbox or for a (public) charging pole or the like is involved. This may have advantages if the control unit of the charging cable is able to more flexibly regulate the current flow (flowing in whatever direction) via the charging cable or is able to better match the needs of the user than is possible with a direct communication between the vehicle and the energy supply unit.

According to an example embodiment of the present invention, the second connection device preferably includes a switch unit. An electrical connection between the energy supply unit and the second connection is activatable or deactivatable via the switch unit. The switch unit may be controlled by the control unit, in particular, to control the charging process or the current flow. Thus, the cable may be advantageously de-energized already directly at the connection to the energy supply unit. The switch unit in the second connection device makes it possible, in particular, for the first connection device and the charging line to be electrically separated from the energy supply unit until the control unit activates a current flow. Thus, on the one hand, a charging process is controllable by the control unit, whereas, on the other hand, a separation of the electrical connection by the switch unit is implementable in an area preferably close to the energy supply unit. This advantageously also enhances the operational safety. If, for example, the second connection device is plugged in at a household power outlet, but the first connection device is not plugged into the mating connector of the vehicle, this would entail, in principle, the risk that a voltage is already present at the first connection device. This may be prevented by the switch unit. Thus, it may be provided, for example, that the control unit is activated only after the presence of the supply voltage. The control unit in turn may check whether it is able to establish a communicative connection to the (hybrid or electric) vehicle or to its energy store, so that it is ensured that no live contacts are openly accessible. Only then is the control unit able to prompt the switch unit to release the current flow.

In one alternative embodiment of the present invention, it is provided that the second connection device has a continuous, in particular, constant, direct and uninterrupted, electrical connection between the first connection and the second connection. Thus, it is particularly advantageously provided that multiple current conductors insulated from one another extend between the first connection and the second connection, the current conductors extending uninterruptedly or continuously. The electrical connection between the first connection and the second connection is designed, in particular, in such a way that no supply voltage for the bypass switch is provided. It is also preferably provided that no passive or active electrical components are provided between the first connection and the second connection. In this case, no supply voltage at all, in particular, is providable, as described above, as a result of which the control unit in the first connection device is unable to become active. This being the case, firstly because the control unit is not supplied with electrical power, secondly because the bypass switch is switched into the first switching state. In this case, the second connection device is suitable, in particular, for connection to a charging infrastructure which, in turn, already includes control units for controlling the charging process of the energy store and/or for communicating with the hybrid vehicle or electric vehicle. Logical components in the second connection device are not necessary in this case.

According to an example embodiment of the present invention, the first connection device preferably includes a communication unit. The communication unit is preferably a radio communication interface. The radio communication interface enables particularly preferably a communication with a user terminal (for example, with a mobile phone, with the vehicle, etc.) and/or with the Internet. Alternatively or in addition, it is preferably provided that the first connection device includes a display module and/or input module, which is preferably designed, for example, to display the current flow or to input a desired charge current intensity or a current flow.

Alternatively or in addition, the first connection device preferably includes an energy measuring module, which is designed to ascertain electrical power that has flowed through the charging cable. The energy measuring module particularly preferably measures the current that has flowed through the charging cable in order, together with the electric voltage present, to ascertain a charging power and, while taking the duration of the current flow further into account, the energy that has flowed. This makes it possible to quantify (also direction-dependent) the electrical energy that has flowed between the energy supply unit and the vehicle, in particular, in order to simplify a billing process and/or in order to give the user, for example, an overview of, for example, the energy (on balance) fed to the vehicle. Alternatively or in addition, it is further advantageously provided that the first connection device includes an authentication module. The authentication module serves, in particular, the purpose of authentication in the energy supply unit in order to thereby display an authorization, for example, for withdrawing energy. An invoice may particularly preferably also be processed via the authentication module, so that the user need only provide his/her personal charging cable or his/her personal first connection device, that is stored, for example, via a database in a billing system. To bill the amount of the energy flow, for example, the energy withdrawn from the energy supply unit, an independent communication advantageously takes place between the authentication module and the energy supply unit. This simplifies the billing process between the user of the power connection and the owner of the power connection, for example, a municipal utility or a power supplier. The payment process for a charging process for the user, for example, is thereby simplified. A complicated authentication with the aid of various apps on a mobile telephone, etc. or via special charge cards for each power supplier may thus be dispensed with.

According to an example embodiment of the present invention, the second connection device in one preferred embodiment includes a temperature monitoring module. The temperature monitoring module is configured to output a temperature information signal to the control unit as a function of a temperature detected in the second connection device. Alternatively or in addition, the temperature monitoring module is designed to adjust and/or to interrupt a current flow through the second connection device. This enables the temperature monitoring module, in particular, to maintain a predefined temperature range. On the one hand, therefore, it is provided that the temperature monitoring module outputs a piece of temperature information to the control unit so that the control unit is able take the aforementioned piece of information about the temperature in the second connection device into account during the charging process. In this case, the piece of temperature information may, for example, be a temperature information signal; thus, for example, a value, that includes, for example, merely two or three stages, multiple stages also being possible. A first stage in this case may, for example, correspond to a state “temperature is in the normal range,” a second stage may, for example, correspond to a state “temperature is increased, but not yet critical,” and a third stage may, for example, correspond to a state “temperature is critical.” Thus, it need not be the ascertained temperature itself. On the other hand, the temperature monitoring module may also independently restrict or interrupt the charge current. In this case, it is provided that these two options, i.e., the transfer of pieces of temperature information and the independent reduction or interruption of the charge current, are provided either alternatively or cumulatively.

In one particularly advantageous embodiment of the present invention, it is provided that the temperature monitoring module includes an evaluation circuit, which is connected to at least one temperature sensor situated in the second connection device. The evaluation circuit provides preferably a temperature signal or a temperature information signal or a status signal as a function of the ascertained temperature, which is transferred, in particular, via at least one electrical conductor of the charging line to the control unit in the first connection device; for example, via an electrical conductor provided as a signal line. The power draw from the energy supply unit may be reduced or interrupted with the aid of the control unit as a function of the status signal. Thus, no direct influence of the evaluation circuit on the charge current, in particular, is provided; instead, it is provided, in particular, that the evaluation circuit informs the control unit via the aforementioned status signal of an instantaneous temperature state. The status signal may, for example, include multiple stages, each stage corresponding to a predetermined status signal. Thus, a first status signal may be output, in particular, when the temperature of the second connection device is in a normal range. A second status signal may be output when the temperature of the second connection device is in a warning range, in which a further rise in temperature is to be avoided.

According to an example embodiment of the present invention, a third status signal may be output, in particular, when the temperature in the second connection device has exceeded a predefined maximum threshold. Alternatively or in addition, the evaluation circuit is designed to independently interrupt the current flow, for example, of the charge current, when the aforementioned maximum threshold is exceeded, as a result of which a redundancy is advantageously created with respect to temperature safety. In this case, the control unit is not needed for interrupting the current flow, but may be redundantly further active.

According to an example embodiment of the present invention, the bypass switch is advantageously situated in the first connection device or in the coupling of the charging line or in the additional coupling of the charging line, the additional coupling being configured to be coupled to an additional connection of the first connection device. A flexible arrangement of the bypass switch, in particular, is thus enabled. Should the bypass switch not be situated in the first connection device, then an additional electrical connection may be provided between the bypass switch and the first connection device, this additional connection extending, in particular, via the combination additional coupling and additional connection and/or through the charging line. The location of the bypass switch may thus be implemented at different points depending on the available space, as a result of which the handling and stowage and the weight distribution of individual components of the charging line may be advantageously improved.

According to an example embodiment of the present invention, the charging line particularly preferably extends continuously between the first connection device and the coupling. This means, in particular, that no electronic components are present in the individual electronic lines. The charging line is thus purely a connection element with no active or passive electrical components (except for the lines as such). The charging line is, in particular, non-detachably attached to the first connection device, the charging line being fed all the way into a housing of the first connection device. “Non-detachably” in this case means that a detaching of the charging line and of the first connection device is not provided or is not possible in a non-destructive way. Feeding the charging line all the way into a housing of the first connection device means that the first connection device does not have to include any cable stub, any additional coupling or a similar electrical cabling. Instead, it involves a single-piece, in particular fixed, object with a permanent housing. As a result, a particularly weather-resistant charging cable, for example, may be created, since the vehicle together with the first connection device may also be exposed to adverse, wet, moist and dirty weather conditions or external surroundings.

The present invention preferably also relates to a connection device, which is provided for use as a first connection device in a charging cable according to the present invention. According to an example embodiment of the present invention, the connection device includes energy transfer means, which are, in particular, contacts or induction coils. The energy transfer means serves as an indirectly or directly detachable wireless and/or wired electrical connection to the energy store of a hybrid vehicle or electric vehicle. The connection device further includes a charging line or an additional connection for electrical connection to a charging line. The connection device further includes a control unit and preferably a bypass switch. The bypass switch is switchable between a first switching state and a second switching state as a function of a type of a second connection device of the charging cable. Respectively one electrical conductor of the charging line is preferably also assigned to at least a portion of the energy transfer means, in particular, to each energy transfer means. This assignment takes place either by an assignment via the additional connection or by a permanent wiring of the respective electrical conductors and energy transfer means. In the first switching state of the bypass switch, an electrical connection is established by the bypass switch between at least one of the energy transfer means and the assigned electrical conductor while bypassing the control unit. In the second switching state of the bypass switch, the control unit is electrically interconnected between the at least one energy transfer means, which is connected in the first switching state via the bypass switch to the assigned electrical conductor, and the respectively assigned electrical conductor. This enables the control unit to control the current flow between the vehicle and the energy supply unit, in particular, to control a charging process. The bypass switch thus makes it possible to use the control unit for controlling the current flow (for example, the charging process), so that it is possible to use a different energy supply unit depending on the presence of the first switching state or of the second switching state. Thus, by using the control unit, for example, it is possible to use a constant electric voltage source or electric continuous voltage source such as, for example, a household power outlet, in particular, without a dedicated communication line, as the energy supply unit, since a control of the current flow (for example, during a charging process), for example, by the charging cable or by the vehicle with the aid of communication via the control unit, is necessary for this purpose. If, on the other hand, the energy supply unit is a dedicated charging infrastructure such as a charging pole or wallbox, which is able to communicate, in particular, independently with the vehicle, then the control unit is not absolutely necessary and may thus be bypassed by the bypass switch.

The present invention further relates to a connection device, which is designed for use as a second connection device of a charging cable or in or on a charging cable as described above. According to an example embodiment of the present invention, the connection device includes a first connection as well as a second connection. The first connection serves as an indirectly or directly detachable wireless and/or wired electrical connection to an energy supply unit. The energy supply unit may be, in particular, a household power outlet and thus a constant electrical voltage source or electrical continuous voltage source, in principle, however, also a dedicated charging infrastructure (also including a dedicated charge controller). The second connection serves as a directly or indirectly detachable wired and/or wireless electrical connection to a charging line of the charging cable. Thus, the connection device is connectable to the charging cable, in particular, in a replaceable manner. Thus, it may be connected to different charging lines. A voltage supply is provided, which is electrically coupled to the first connection and which provides a first supply voltage when an electrical voltage is present at the first connection. The electrical supply voltage may be output to the charging line via the second connection. Finally, a switch unit is provided, via which an output of an electrical voltage provided by the energy supply unit is activatable or deactivatable at the second connection. The switch unit is controllable via the second connection. Thus, it is provided, in particular, that when connecting the second connection device to the energy supply unit, initially no power is transferred. Instead, initially only the supply voltage is output which in turn signals to the remaining components of the charging cable that a connection to the energy supply unit is present. The remaining components of the charging cable, in particular, a control unit in a first connection device of the charging cable, are thus able to independently start, stop and control the charging process or to prompt the vehicle or its battery or energy store to control the current flow. For this purpose, a corresponding activation of the switch unit via the second connection is necessary. Thus, on the one hand, a control, at least a starting and stopping, of the charging process is made possible, an interruption of the charge current also taking place in close proximity to the energy supply unit when the switch unit is deactivated. This minimizes that section of the charging cable and the second connection device that is permanently subjected to an electric voltage. The switch unit may, for example, also be controllable, in particular, deactivatable by a temperature monitoring module.

The term “charging” in this case is understood to mean an example of an energy transfer between the vehicle and the energy supply unit.

The charging cable has, among others, the advantages that the charging is able to take place regardless of whether it is at a charging station, a continuous current power outlet or switchable power outlet and the charging process takes place in a rapid and otherwise uncomplicated manner.

For this purpose, according to an example embodiment of the present invention, a charging cable is preferably provided for electrically charging an energy store of a hybrid vehicle or electric vehicle, the charging cable including a charging line, the charging lines including a first connection device, the first connection device being electrically connectable in a detachable manner to the energy store of the hybrid vehicle or electric vehicle, the charging line including a second connection device, the second connection device being electrically connectable in an indirectly or directly detachable manner to an energy supply unit, the charging cable including at least one control unit and/or at least one switch unit and/or at least one communication unit. The advantage of this charging cable is the implementation of a compact, universally usable, mobile charging solution for the driver or the person charging and of a simple, cost-efficient installable charging infrastructure for the charging station provider. The charging process is advantageously started without having to initiate for this purpose a previous identification and authorization of the charge current requestor via an RFID card, a connection to the mobile telephone or a credit card. Thus, no additional action not directly related to the charging process is required for the charge current requestor. It is sufficient enough merely to plug in the cable, since the system is self-authorizing. Advantageous refinements of the device of the present invention are possible as a result of the measures disclosed herein.

According to an example embodiment of the present invention, the at least one control unit and/or the at least one switch unit and/or the at least one communication unit is/are advantageously placed along the charging line. This results in a compact and mobile charging solution for the person charging. In addition, the connection device/plug may be designed to be small, which results in a reduced pull on the connection device.

According to an example embodiment of the present invention, the at least one control unit and/or the at least one switch unit and/or the at least one communication unit are advantageously placed in the first connection device or along the charging line. The division between control unit, switch unit and communication unit between the connection device and the charging line advantageously allows for the implementation of a compact design by relocating parts of the functionalities into the charging cable.

According to an example embodiment of the present invention, it is further advantageous that the at least one control unit and/or the at least one switch unit and/or the at least one communication unit is/are placed in the first connection device. By situating these units in the connection device, the essential functionalities with respect to charge control, authorization and identification are placed in the connection device and thus in the plug of the charging cable in a compact manner.

According to an example embodiment of the present invention, it is further advantageous that the at least one communication unit communicates wired and/or wirelessly. The communication unit may advantageously communicate by cable with the vehicle or also using a switchable power outlet by carrying out an identification, for example, and by releasing the switchable power outlet for use after a check. Communication with a charge controller or user interface or energy meter advantageously takes place with the aid of the wireless communication.

According to an example embodiment of the present invention, the switch unit advantageously activates or deactivates a current flow through the charging cable. If the charging cable is connected to a continuous current power outlet, the current flow through the charging cable advantageously takes place only when the switch unit activates the charge current.

The at least one switch unit is further advantageously suitable for de-energizing the current flow through the charging cable as a function of a fault current monitoring and temperature monitoring, as a result of which the safety of the charging process is increased and charging may safely take place in older buildings without an F1 circuit breaker.

According to an example embodiment of the present invention, the control unit is advantageously suitable for regulating the maximum current intensity to be withdrawn for charging the energy store. Depending on under what conditions the charging cable is used for charging (wallbox, charging station, switchable power outlet, continuous current power outlet, etc.) the control unit regulates the current intensity suitable for the respective case.

According to an example embodiment of the present invention, the communication unit is suitable for being advantageously connected in a plugged-in state of the charging cable to a switchable power outlet of the energy supply unit when the charging cable identifies the power outlet, authorizes the power outlet and switches a current for the charging cable in the power outlet with the aid of the communication unit. The switchable power outlet, which is permanently installed or fixedly mounted, for example, is thus unable to be indiscriminately used by unauthorized charging cables for charging an energy store, but may only be enabled using this charging cable.

### BRIEF DESCRIPTION OF THE DRAWINGS

Exemplary embodiments of the present invention are described in detail below with reference to the figures.

FIG. 1 schematically shows a representation of a vehicle, which is connected via a charging cable according to one exemplary embodiment of the present invention to an energy supply unit.

FIG. 2 schematically shows a first depiction of the design of the charging cable according to the exemplary embodiment of the present invention.

FIG. 3 schematically shows a second representation of the design of the charging cable according to the exemplary embodiment of the present invention.

FIG. 4 schematically shows a third representation of the design of the charging cable according to the exemplary embodiment of the present invention.

FIG. 5 schematically shows a representation of a charging cable and of a continuous current power outlet, according to an example embodiment of the present invention.

FIG. 6 schematically shows a further representation of a charging cable and of a switchable power outlet, according to an example embodiment of the present invention.

FIG. 7 schematically shows a further representation of a charging cable and of a charging station or wallbox, according to an example embodiment of the present invention.

### DETAILED DESCRIPTION OF EXAMPLE EMBODIMENTS

All figures are merely schematic representations of the device according to the present invention or of its components according to exemplary embodiments of the present invention. Distances and size relations, in particular, are not reproduced true to scale in the figures. Elements in the various FIGS. corresponding to one another are provided with the same reference numerals.

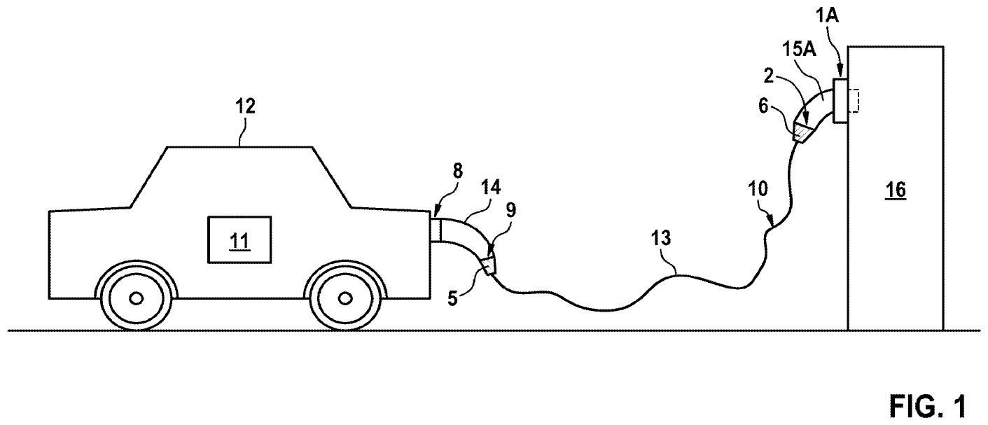

FIG. 1 schematically shows a hybrid vehicle or electric vehicle 12 including an energy store 11. Energy store 11 is to be charged via an energy supply unit 16, energy supply unit 16 in the case shown in FIG. 1 being a charging pole, which enables a charging with a three-phase alternating voltage. A charging cable 10 according to one exemplary embodiment of the present invention is provided for connecting energy supply unit 16 and energy store 11 or hybrid vehicle or electric vehicle 12.

Charging cable 10 includes a first connection device 14 and a second connection device 15, a charging line 13 being present between first connection device 14 and second connection device 15. First connection device 14 is used for electrical connection to the hybrid vehicle or electric vehicle 12 and, specifically, to energy store 11. Second connection device 15 is used for connection to energy supply unit 16.

First connection device 14 includes energy transfer means (i.e., energy transfer arrangement) 8, which are provided for directly or indirectly detachable wireless or wired electrical connection to energy store 11. This particularly preferably involves contacts, for example, plug contacts or induction coils in order to establish the electrical connection. The electrical connection may be established either in a wired or wireless manner such as, for example, inductively or capacitively. In the electrically connected state, (electrical) power is able to be transferred between the first connection device and the counter-connection connected thereto.

In the embodiment shown, first connection device 14 also includes an additional connection 9, via which a wireless and/or wired electrical connection to an additional coupling 5 of the charging line 13 is establishable in a directly or indirectly detachable manner. In one alternative embodiment, the additional connection 9 as well as additional coupling 5 may be dispensed with, so that charging line 13 is attached directly at first connection device 14 and is not separable from the latter without being damaged.

A second connection device 15, 15A, 15B is used for electrically connecting charging cable 10 to energy supply unit 16, a first type of second connection device 15A being shown in FIG. 1. In this embodiment, second connection device 15A is provided for connection to a charging infrastructure as energy supply unit 16, which enables, for example, a three-phase charging. The charging infrastructure as energy supply unit 16 already includes, for example, a charge control logic and is thus able to communicate directly with energy store 11 and/or with hybrid vehicle or electric vehicle 12. Second connection device 15A includes a first connection 1A and a second connection 2, first connection 1A being designed to electrically connect with energy supply unit 16. Second connection 2 is used for connecting to charging line 13. Charging line 13 includes for this purpose a coupling 6, coupling 6 and second connection 2 being electrically connectable in a detachable manner. Thus, second connection device 15 may be replaced easily and with little effort by simply separating the connection between coupling 6 and second connection 2.

First connection A1 serves as an indirectly or directly detachable wireless or wired electrical connection to energy supply unit 16. The aforementioned electrical connection may take place, for example, via contacts, for example, plug contacts, or capacitively or inductively (for example, via coils). The same applies to the electrical connection between second connection 2 and coupling 6; here too, an indirectly or directly detachable electrical connection is preferably provided, which may be wireless or wired.

In this exemplary embodiment, charging line 13 merely includes electrical conductors between coupling 6 and additional coupling 5, which establish an electrical connection between coupling 6 and additional coupling 5. These electrical conductors are copper conductors or aluminum conductors, for example, or are formed from another material having a higher conductivity and include an electrical insulation. All electrical conductors are combined to form a strand and preferably have a shared sheath, which serves on the one hand as an electrical insulation and on the other hand as mechanical protection. Preferably, no active or passive electrical components at all are provided in charging line 13. All logical components and, in particular, active or passive electrical components are either part of first connection device 14 or part of second connection device 15A. As a result, the charging line may be manufactured in an advantageously cost-efficient manner.

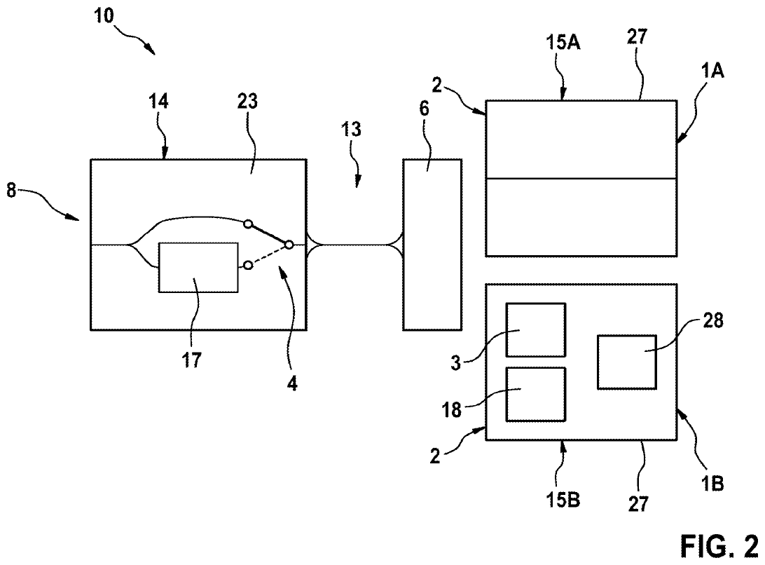

FIG. 2 schematically shows an overview of the mode of operation and the design of charging cable 10. In the embodiment shown in FIG. 2, additional coupling 5 of charging line 13 as well as additional connection 9 of first connection device 14 are omitted. Instead, charging line 13 is fed directly into a first housing 26 of first connection device 14. There, it is non-detachably fastened, for example, (i.e.: detachably not without being damaged) or fixed or attached or connected.

Charging line 13 thus includes only coupling 6, at which either a first type of second connection device 15A or a second type of second connection device 15B may be attached, in particular, detachably without being damaged. In principle, more than two different types of connection devices are attachable at coupling 6. The different types of second connection device 15A, 15B enable the connection to different power supply units 16, in particular, for example, to a household power outlet, which permanently provides electrical power, but includes no charge control logic and/or no communication line, and to a dedicated charging infrastructure, which already contains a corresponding charge control logic and/or a communication line and is capable of enabling multiphase charging or an energy transfer.

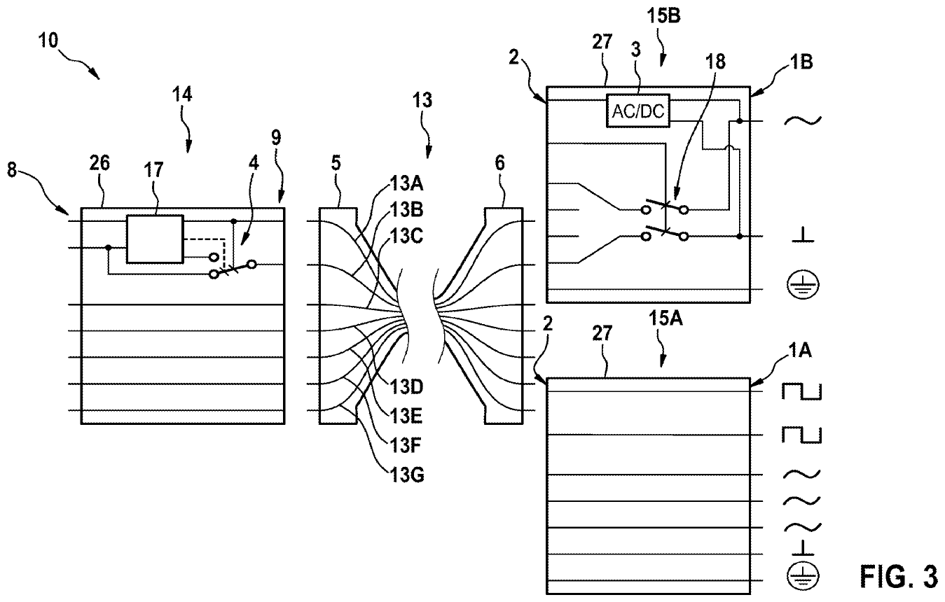

In this—merely exemplary—specific embodiment, first connection device 14 includes a bypass switch 4 as well as a control unit 17. Bypass switch 4 may be switched between a first switching state and a second switching state, in the first switching state, control unit 17 being bypassed (in FIG. 2: the upper solid-line path), whereas in the second switching state, control unit 17 being interconnected into the electrical path of charging cable 10 (in FIG. 2: the lower dashed-line path). In the present exemplary embodiment, bypass switch 4—also for reasons of clarity—is represented as being designed separately from control unit 17. Bypass switch 4 may, in principle, however, also be integrated into control unit 17. In this case, the first switching state is to be understood in such a way that the elements of control unit 17 functionally required for control are bypassed in any case with respect to the line in which bypass switch 4 is situated. The details regarding this switching process are explained below with the description of FIG. 3. Thus, control unit 17 is selectively activatable or deactivable by bypass switch 4, the switch-over between the first switching state and the second switching state taking place as a function of the type of second connection device 15A, 15B. This enables charging cable 10 to be selectively used as intelligent charging cable 10 (second switching state) or as non-intelligent charging cable (first switching state), depending on whether or not a charge control logic is required or desired based on the type of second connection device 15. For this purpose, a user of charging cable 10 preferably is not required to manually prompt any switching processes, instead, the switch-over of bypass switch 4 takes place preferably via second connection device 15A, 15B. Thus, the user is required only to attach second connection device 15A, 15B suitable for the instantaneous charging situation to charging line 13, for example, with the aid of coupling 6, in order to properly configure charging cable 10.

If the first type of second connection device 15A is coupled to coupling 6, then it is provided that a direct connection of first connection 1A to coupling 6 takes place via second connection 2. Relevant details are in turn explained below with the description of FIG. 3. If the first type of second connection device 15A is used, then charging cable 10 is provided, in particular, for connecting to a charging infrastructure as energy supply unit 16. In this case, no inherent logic at all is required within charging cable 10, which is why control unit 17 is bypassed by bypass switch 4. Charging cable 10 thus serves as a non-intelligent charging cable and enables a communication of energy store 11 or of hybrid vehicle or electric vehicle 12 directly with energy supply unit 16.

If, on the other hand, a second type of second connection device 15B is used, then first connection 1B of second connection device 15B is used, in particular, to connect to a household power outlet, for example, via a, for example, country-specifically designed safety plug. In this case, no charge control logic at all nor any communication line or signal line by energy supply unit 16 is provided, which is why in this exemplary embodiment multiple active components are situated within second connection device 15. In this case, control unit 17 (in first connection device 14) is also required as the charge controller for the charging process or for the energy transfer process. Therefore, bypass switch 4 must be switched into the second switching state in order to avoid a bypass of control unit 17 and to integrate control unit 17 into the electrical path of charging cable 10.

It is understood that a second connection device 15B of the second type may also be used, in principle, even when using the energy supply unit described further above with a dedicated communication line or signal line. This may be desirable, for example, if the user expects advantages from the fact that the energy transfer does not take place via a direct communication of the vehicle or of the energy store with the supply unit, but rather that control unit 17 is to be purposely interconnected.

It is further to be understood that the switch-over of bypass switch 4 may be implemented in various ways. It is important that the switch-over takes place merely as a function of the type of second connection device 15A, 15B. One specific embodiment to be understood as merely exemplary is described below, which shows how bypass switch 4 may be switched over as a function of the type. In principle, other implementations (for example, via wireless or wired transfer of pieces of information about the type of the second connection device) are, of course, also possible, the setting of the respective switching state then taking place based on the transferred or received or read-in pieces of information.

The second type of second connection device 15B includes here merely by way of example a voltage supply 3 and a switch unit 18. If a connection of first connection 1B of second connection device 15B with energy supply unit 16 takes place, then switch unit 18 initially remains open, as a result of which an interruption of the voltage supply is achieved. Charging line 13 and first connection device 14 are thus not directly electrically coupled to energy supply unit 16. A supply voltage is provided solely by voltage supply 3, it being, in particular, a direct voltage in this case. Voltage supply 3 provides the supply voltage to bypass switch 4 and/or control unit 17 via coupling 6 and charging line 13. Thus, either bypass switch 4 may be switched directly via the presence of the supply voltage by designing bypass switch 4, for example, as a relay or a MOSFET or the like. Alternatively, bypass switch 4 may also be switched by control unit 17, control unit 17 here being supplied initially by voltage supply 3 with electrical power and then switching the bypass switch over (into the second switching state). Thus, in both exemplary cases, control unit 17 becomes active and is subsequently able to control the charging process of energy store 11. For this purpose, control unit 17 is preferably designed to output a corresponding signal to switching unit 18 in order to establish the electrical connection between energy supply unit 16 and energy store 11. After its activation (bypass switch 4 in the second switching state) control unit 17 preferably also communicates with vehicle 12 or energy store 11 of vehicle 12, and prompts vehicle 12 or energy store 11, for example, not to exceed a maximum transfer current intensity, or more specifically, charge current intensity, during the energy transfer. The charge control is thus carried out between control unit 17 and vehicle 12 or its energy store 11.

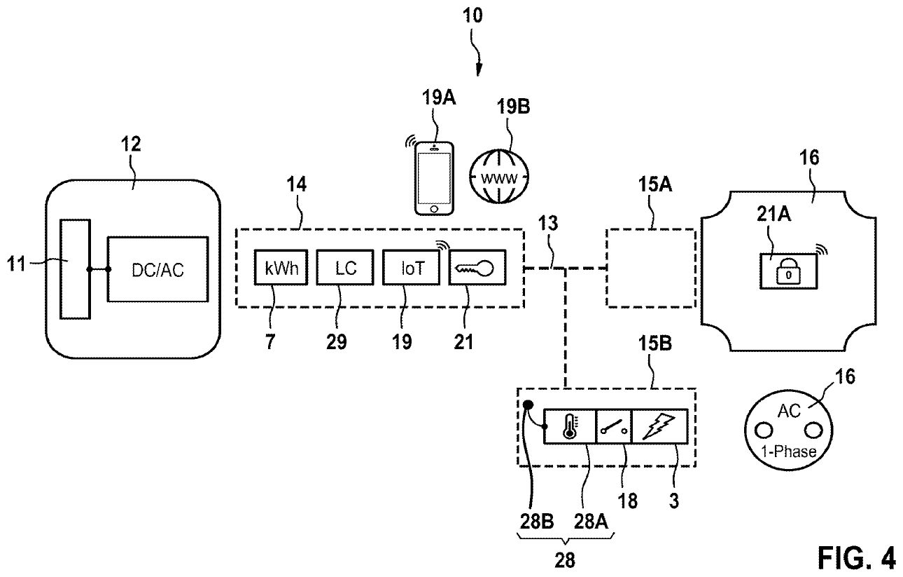

Second connection device 15B particularly advantageously also includes a temperature monitoring module 28. Temperature monitoring module 28 is used to read in or ascertain or detect a temperature of second connection device 15B, so that an overloading of second connection device 15B due to excessive temperatures is preventable. The mode of operation of temperature monitoring module 28 is explained below with the description of FIG. 4.

It is understood that bypass switch 4 may, in principle, also be situated in charging line 13.

FIG. 3 also schematically shows a design of charging cable 10, a greater degree of detail than in FIG. 2 being shown. Here, too—merely exemplary and for reasons of clarity—bypass switch 4 is again represented separately from the control unit. In addition, additional coupling 5 of charging line 13 and additional connection 9 of first connection device 14 are shown in this embodiment, so that first connection device 14 is designed to be detachable from charging line 13. As described above, multiple electrical conductors 13A, 13B, 13C, 13D, 13E, 13F, 13G extend between additional coupling 5 and coupling 6. All of electrical conductors 13A, 13B, 13C, 13D, 13E, 13F, 13G are designed as continuous between coupling 6 and additional coupling 5 and, in particular, are not physically interrupted by other electrical components. Thus, no active or passive electrical component at all is present between coupling 6 and additional coupling 5.

As explained above, first connection device 14 includes a plurality of energy transfer means 8, which are provided for electrical connection to energy store 11. Each energy transfer means 8 is assigned an electrical conductor 13A, 13B, 13C, 13D, 13E, 13F, 13G, every combination of energy transfer means 8 and associated electrical conductors 13A, 13B, 13C, 13D, 13E, 13F, 13G being provided either for transferring a signal or for transferring an electrical charging power. In this way, at least one neutral conductor, one protective ground as well as a three-phase electrical voltage connection as well as two signal lines are particularly advantageously implemented.

In the first switching state, an electrical connection is established via bypass switch 4 between at least one energy transfer means 8 and respectively assigned electrical conductors 13A, 13B, 13C, 13D, 13E, 13F, 13G while bypassing control unit 17. In the second switching state, control unit 17 is electrically interconnected between energy transfer means 8, which are connected in the first switching state via bypass switch 4 to associated electrical conductors 13A, 13B, 13C, 13D, 13E, 13F, 13G, and respectively assigned electrical conductors 13A, 13B, 13C, 13D, 13E, 13F, 13G in order to control an energy transfer process, for example, a charging process. This applies, in particular, to such energy transfer means 8 and associated electrical conductors 13A, 13B, 13C, 13D, 13E, 13F, 13G, which form a signal line. In FIG. 3, a first conductor 13A and a second conductor 13B each form a signal line, in each case with the respectively assigned energy transfer means 8. One of the signal lines, which extends via second conductor 13B, may thus be switched over by bypass switch 4 in order to either include control unit 17 or to bypass control unit 17. This means that in the first switching state a (here: direct) connection is established between second conductor 13B and associated energy transfer means 8, control unit 17 being bypassed. In contrast, control unit 17 is switched in the second switching state between second electrical conductor 13B and associated energy transfer means 8. The remaining electrical conductors 13C, 13D, 13E, 13F, 13G as well as associated energy transfer means 8 are permanently connected when a connection is established between additional coupling 5 and additional connection 9.

Bypass switch 4 is normally located in the first switching state. If a first type of second connection device 15A is used and is electrically coupled to coupling 6 of charging line 13, then a (direct) electrical connection ultimately takes place between energy transfer means 8 and first connection 1A of second connection device 15A while bypassing control unit 17, the signal line formed by first conductor 13A not being absolutely necessary in this case and remaining unused. Control unit 17 is not supplied with electrical power and remains inactive. A communication between energy store 11 or hybrid vehicle or electric vehicle 12 and energy supply unit 16 is made possible via the signal line formed by second conductor 13B, since this signal line is directly connected through by bypass switch 4 while bypassing control 17.

If, on the other hand, a second type of second connection device 15B is used, then control unit 17 is advantageously used and actively connected. Here, merely as an example, the connection of second connection device 15B to a normal household power outlet, for example, a safety outlet including a neutral conductor, a phase conductor and a protective conductor, would take place.

The activation of control unit 17 occurs here, for example, by second connection device 15B initially providing a supply voltage through voltage supply 3, which is output via first conductor 13A to control unit 17. Voltage supply 3 in this case converts, for example, an alternating current received from voltage supply 16 merely by way of example into a direct current, for example, a direct current between 5 V and 50 V, preferably between 10 V and 25 V. Control unit 17 is thus supplied with electrical power and thus becomes active. In addition, bypass switch 4 is switched over into the second switching state, so that the signal line that is established by second conductor 13B is activatable by control unit 17. The switch-over of bypass switch 4 may take place either via the supply voltage of voltage supply 3 or, alternatively, via an activation signal of control unit 17. It is understood that other specific embodiments are also possible, which initiate a switch-over of bypass switch 4 when a second connection device 15B of one type is connected to charging cable 10, in which control unit 17 is to be activated or is not to be bypassed.

Should energy store 11 and/or hybrid vehicle or electric vehicle 12 attempt to communicate via those energy transfer means 8 that are assigned to first conductor 13A and second conductor 13B, then this communication now takes place only with control unit 17. Control unit 17 is thus able to function as a charge control logic with respect to energy store 11 and/or hybrid vehicle or electric vehicle 12 and to control the charging process. This includes, in particular, the negotiating of a charging power, which is expected by energy store 11 and/or hybrid vehicle or electric vehicle 12. Once the charging process is to be started an activation of switch unit 18 takes place, here, for example, via second conductor 13B, which is no longer directly connected to associated energy transfer means 8 due to bypass switch 4 and which therefore is unable to receive any communication signals from energy store 11 and/or from hybrid vehicle or electric vehicle 12. In other words, control unit 17 may switch over switch unit 18 via the aforementioned second conductor 13B. Switch unit 18 is switched, here, for example, normally in an open position. The effect of this is that there is initially no flow of electrical power that is intended to flow between vehicle 12 and energy supply unit 16. If, for example, this entails a charging process, then energy, which is provided by energy supply unit 16, is not passed to charging line 13 and to first connection device 14. This takes place only when the charging process is to be started. Thus, control unit 17 has full control over the charging process and is able to influence its start and stop via switch unit 18. In one particularly advantageous embodiment, a charge current intensity may also be adjusted via switch unit 18.

Charging cable 10 may thus be connected to different energy supply units 16, charging cable 10 functioning as an intelligent charging cable or as a non-intelligent charging cable depending on external requirements. This simplifies considerably the charging process for a user, since the user need merely attach the proper second connection device 15, 15A, 15B to charging line 13. An independent configuration of charging cable 10 then takes place in order to achieve a desired electrical energy transfer process, for example, a desired charging situation.

First connection device 14, as described above, includes a first housing 26, which may be variously designed. In FIG. 2, a variant has been shown, in which both energy transfer means 8 as well as charging line 13 are formed on first housing 23. In the variant shown in FIG. 3, first connection device 14 includes a first housing 26, in which energy transfer means 8 and additional connection 9 are designed for connection to additional coupling 5. Thus, the result is, in particular, that all components of first connection device 14 are situated in a shared housing, first housing 26. First connection device 11 thus does not include, in particular, any cable stub or the like in order to connect charging line 13. Alternatively, charging line 13 may, however, also be coupled directly and detachably not without being damaged to first connection device 14.

Second connection device 15, 15A, 15B includes a second housing 27, at which both first connection 1A, 1B as well as second connection 2 are formed. Thus, the design is similar to the design of first connection device 14. For second connection device 15, 15A, 15B as well, it is the case that all components are situated in a shared housing, second housing 27. In this way as well, the provision of a cable stub or the like is, in particular, avoided.

If the charging cable is connected to a switchable power outlet on the side of energy supply unit 16, then in the second connection device 15B, for example, the switch unit may be bridged or omitted or functionally disabled (for example, via electronics) or be used only as an emergency switch-off or emergency reduction in the case of temperature overheating. For a switch-off or reduction of the current flow, control unit 17 in this case may, for example, resort to the switch function of the switchable power outlet or communicate for this purpose with the switchable power outlet.

FIG. 4 is a further depiction, which schematically shows the design of charging cable 10. In this case, the logical design of charging cable 10, in particular, is represented.

In addition to the above-described components, first connection device 14 advantageously includes an energy measuring module 7. Energy measuring module 7 advantageously serves to ascertain an electrical energy that has flowed through charging cable 10. For this purpose, the energy measuring module advantageously measures a current flow as well as a present electrical voltage in order to ascertain therefrom, for example, initially the electrical power that has flowed through charging cable 10. The energy may be ascertained by recording the time during which the respectively ascertained power flows. This also makes it possible to ascertain a degree of aging of charging cable 10.

First connection device 14 also advantageously includes a display module and/or input module 29. This may be, in particular, a touchscreen or a display or an input device. A desired charge current intensity may, in particular, be input and/or displayed via display module and/or input module 29.

It is further preferably provided that first connection device 14 includes a communication unit 19. Communication unit 19 is, in particular, a radio communication interface. Communication unit 19 is used preferably for communicating with a user terminal 19A, (for example, a mobile communication device, a tablet or also the vehicle or its communication module, etc.) and/or with Internet 19B. In this way, it is possible to simply and reliably output pieces of information via the charging process to the user. At the same time, the user is able to enter inputs such as, for example, the above-mentioned desired charge current intensity.

First connection device 14 preferably also includes an authentication module 21. Authentication module 21 enables an authentication in energy supply unit 16, a communication with an authentication counter-module 21A, in particular, taking place. Once a corresponding authentication by authentication module 21 and authentication counter-module 21A has taken place, energy supply unit 16 enables the transfer of electrical energy. This ensures on the one hand that only authorized users are able to carry out an energy transfer between the vehicle and energy supply unit 16, and on the other hand, a billing for the energy transfer may be achieved in this way. As a result, a separate log-in of the user at energy supply unit 16 is not necessary, instead, an independent authentication and/or billing takes place via authentication module 21 and authentication counter-module 21A and thus ultimately by using the first connection device.

The aforementioned components, i.e., energy measuring module 7, display module or input module 29, communication unit 19, and authentication module 21, simplify the handling of charging cable 10 for the user. This allows convenience functions such as the above-described billing to be carried out easily and with little effort. Thus, the energy transfer, for example, a charging process, is designed to be as simple as possible for the user.

If charging cable 10 includes the first type of second connection device 15A in order to be connected to a charging infrastructure, then further monitoring measures are not necessary. If, on the other hand, the second type of second connection device 15B is present, then—depending on the energy supply unit used, for example, a household power outlet—for example, only a single-phase charging is enabled. Above-described temperature monitoring module 28 is advantageously provided in this case. Here, temperature monitoring module 28 includes, for example, an evaluation circuit 28A and a temperature sensor 28B. Evaluation circuit 28A is connected to temperature sensor 28B, a temperature of second connection device 15B being detectable by temperature sensor 28B. Temperature monitoring module 28 may fulfill various functionalities, which is described below.

It is understood in this case that temperature monitoring module 28 as such does not necessarily have to include the temperature sensor. It reads in or ascertains temperature signals.

On the one hand, it is provided that evaluation circuit 28A provides a status signal as a function of a temperature, which evaluation circuit 28A reads in and which is ascertained, for example, with the aid of temperature sensor 28B. The status signal is transferrable, for example, via one of electrical conductors 13A, 13B, 13C, 13D, 13E, 13F, 13G to first connection device 14 and, in particular, to control unit 17; it may, however, in principle also be transferred, for example, wirelessly or via other lines. Control unit 17 is thus able to control the energy transfer process, for example, the charging process, based on the temperature information. The status signal may indicate, in particular, various temperature levels, so that, for example, different status signals are provided by evaluation unit [sic; circuit] 28A when the temperature of second connection device 15B moves in various predefined temperature ranges. Thus, a first status signal, in particular, may indicate that the temperature lies in a non-critical range. A second status signal may indicate that a temperature lies in an elevated range, such that control unit 17, upon receipt of the second status signal, is able to ensure a reduction of the current flow (for example, by the control unit telling vehicle 12 or energy store 11 to reduce the current flow or by the control unit acting on switch unit 18). On the other hand, should a third status signal be provided, then this signal indicates that a predefined maximum temperature is exceeded, as a result of which the charging process is to be stopped. The stopping of the charging process may take place either via control unit 17 by the control unit separating the current flow through switch unit 18 and/or by notifying vehicle 12 or energy store 11 that the energy transfer is to be terminated. Alternatively, the stopping of the charging process may also take place via evaluation circuit 28A itself, either by evaluation circuit 28A activating switch unit 18 or by temperature monitoring module 28 including a dedicated interrupt switch, which is activatable by evaluation circuit 28A. In this way, a charging process may only take place in a predefined temperature range of the second connection device. As a result, an overheating and, potentially, a burning, in particular, of energy supply unit 16 or of the connecting infrastructure may be advantageously avoided.

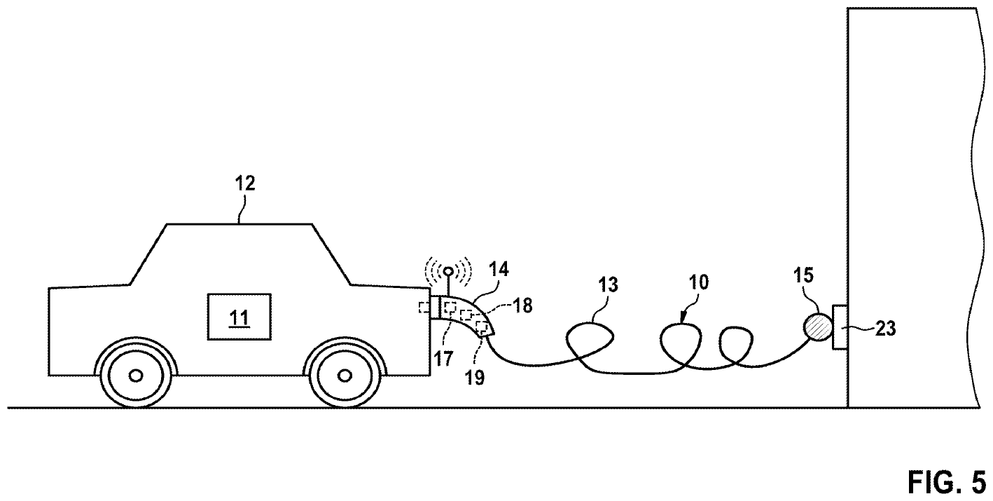

FIG. 5 schematically shows a representation of a charging cable 10 and a continuous current power outlet 23. Charging cable 10 includes a first connection device 14, connection device 14 being electrically usable in a detachable manner with energy store 11 of hybrid vehicle or electric vehicle 12. Connection device 14 is preferably a Type 2 plug connector. Charging cable 10 further includes a charging line 13 and a second connection device 15. Connection device 15 in this case may be designed as a household plug (safety type F, all EU countries, US, CN, etc.) or a CEE plug (blue red—for industrial power outlets) or a Type 2 plug. Alternatively, second connection device 15 may also be designed as an adapter, so that the aforementioned plug types (household plug, CEE plug, Type 2 plug, etc.) may be connected to this adapter. Connection device 14 is provided for the vehicle side, connection device 15 is provided for the connection of charging cable 10 to energy supply unit 16, in this case, continuous current power outlet 23. Connection device 14 includes a control unit 17, a switch unit 18, and a communication unit 19. Alternatively, control unit 17, switch unit 18, communication unit 19 may also be situated completely in charging line 13 of charging cable 10 or may be distributed at least partially along the charging line and the connection device (for example, communication unit 19 in connection device 14 and control unit 17 and switch unit 18 along charging line 13—or alternative distribution). If the driver plugs charging cable 10 into vehicle 12 and connects it to continuous current power outlet 23, charging cable 10 is initially de-energized by switch unit 18. Control unit 17 recognizes the plugged-in state in a continuous current power outlet 23. Control unit 17 subsequently takes over the charge control, regulation and activates/deactivates the charge current via the switch unit. It is optionally possible to intervene in the charge control via communication unit 19 and to deactivate or also to reduce the charge current using switch unit 18.

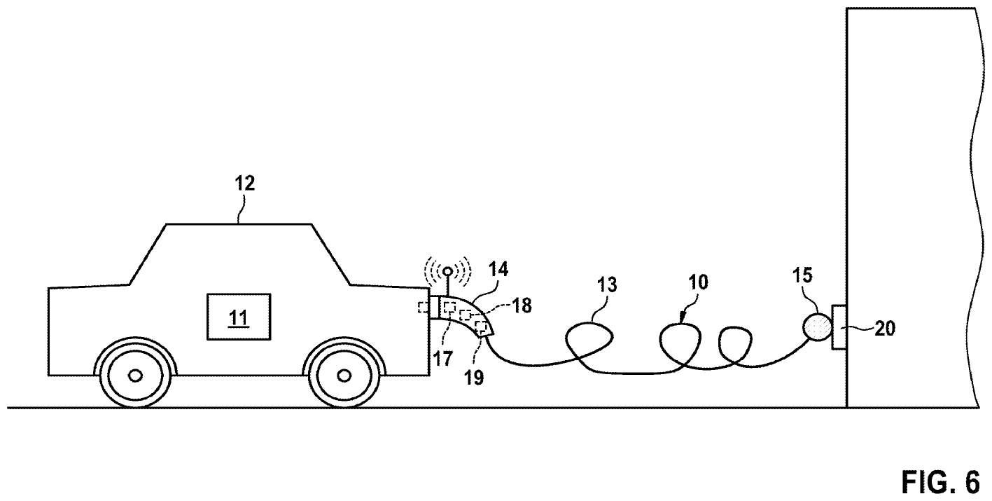

FIG. 6 shows a further specific embodiment of the present invention. A further schematic representation of a charging cable 10 and a switchable power outlet 20 is shown. Identical elements with respect to FIG. 5 are provided with identical reference numerals and are not explained in further detail. In this exemplary embodiment, charging cable 10 is connected to an apparent power outlet 20. Charging cable 10 is connected via communication unit 19 to switchable power outlet 20. Communication unit 19 in this case is connected either wired or wirelessly to power outlet 20. In the process, power outlet 20 is identified (for example, via MAC addresses, WIFI password, LoRaWan, etc.), power outlet 20 is authorized, and the current for charging cable 10 is connected through in power outlet 20. In the event that charging cable 10 is connected to a switchable power outlet 20, switch unit 18 handles no further function since the circuit function is handled by power outlet 20. Optionally, however, switch unit 18 may carry out a safety switch-off within connection device 14 if fault currents or safety-relevant, excessive temperature values are detected. Communication unit 19 includes an IoT (Internet of Things) interface and utilizes WLAN/LoRaWan, etc. and has a user interface, via which the driver or the person charging is able to influence and view the charging process. Communication unit 19 further includes an energy measurer or an electricity meter (for calculating the amount of charged current) and—in the case of multiple vehicles being charged—allows with the aid of multiple charging cables 10 a communication of charging cables among one another in order to ensure an efficient charge management.

In the process, the communication unit handles the communication between the individual charging cables 10 in the surroundings (parking garage/parking facility/parking space etc.) or an alternative base station 24 wirelessly or by cable. Communication unit 19 in this case forwards the details to the charge control regarding the maximum amount of current available and the charge control regulates this or connects or switches the charge current on or off via switch unit 18. Communication unit 19 reads the instantaneous charging power from the charge control (control unit 17) and transfers this wirelessly or by cable to the individual charging cables 10 in the surroundings (parking garage/parking facility/parking space, etc.) or to a base station 24. With communication unit 19, it is also possible to operate charging cable 10 as a very compact, mobile charging pole and to dynamically control the charging process via “OCPP” (Open Charge Point Protocol) or a smartphone connection (for example, via communication interface) (for example, active charge management, time-controlled, individual, prioritized charging profiles, electricity metering, billing). Billing data, network data and service data are generated, stored and retrieved (according to OCPP). The buffering takes place in a non-volatile memory 25 (not represented here) in charging cable 10, so that a verifiability of the date is available. Users of a switchable Type 2 power outlet may furnish to/approve for persons selected by them their access authorization for charging cable 10 (so-called Whitelist) or forward the access password to those persons.

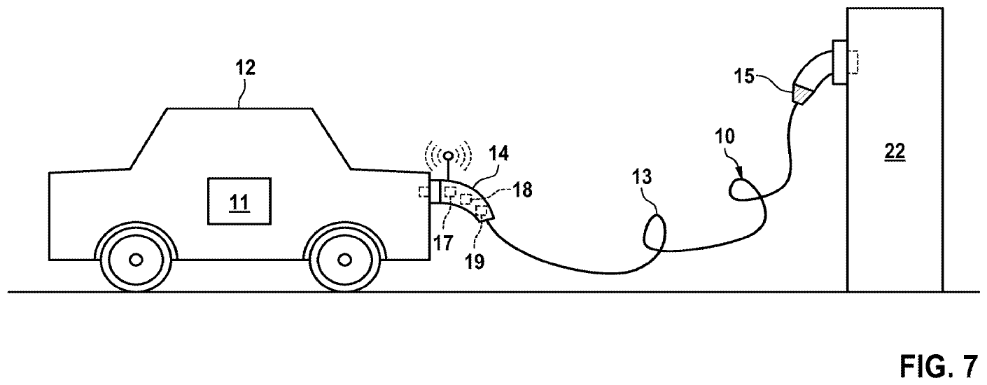

FIG. 7 shows a further specific embodiment of the present invention. A further schematic representation of a charging cable 10 and a charging station or wallbox 22 is shown. Identical elements with respect to FIG. 5 or FIG. 6 are provided with identical reference numerals and are not explained in further detail. If charging cable 10 is plugged into a charging pole 22 (or charging station) or wallbox 22, control unit 17 recognizes the plugged-in state in the charging station or wallbox and its maximum available power. In this case, control unit 17 transfers the charge control to the charging station or wallbox 22. It is optionally possible to intervene in the charge control of charging pole 22 via communication unit 19 and to switch off or reduce the charge current using switch unit 18. By coding connection device 15 on the mains side, it is possible to automatically recognize the maximum possible charge power.

The present invention is also described by the following points:
(A) charging cable 10 for electrically charging an energy store 11 of a hybrid vehicle or electric vehicle 12, including a charging line 13, charging line 13 including a first connection device 14, first connection device 14 being electrically connectable in a detachable manner to energy store 11 of hybrid vehicle or electric vehicle 12, charging line 13 including a second connection device 15, second connection device 15 being indirectly or directly electrically connectable in a detachable manner to an energy supply unit 16, charging cable 10 including at least one control unit 17 and/or at least one switch unit 18 and/or at least one communication unit 19.
(B) charging cable 10 as defined in point (A), the at least one control unit 17 and/or the at least one switch unit 18 and/or the at least one communication unit 19 being placed along charging line 13.
(C) charging cable 10 as defined in point (A), the at least one control unit 17 and/or the at least one switch unit 18 and/or the at least one communication unit 19 being placed in first connection device 14 or along charging line 13.
(D) charging cable 10 as defined in point (A), the at least one control unit 17 and/or the at least one switch unit 18 and/or the at least one communication unit 19 being placed in first connection device 14.
(E) charging cable 10 as defined in point (A) or point (B) or point (C) or point (D), the at least one communication unit 19 communicating by hardwire and/or wirelessly.
(F) charging cable 10 as defined in point (A) or point (B) or point (C) or point (D), the at least one switch unit 18 being suitable for activating or deactivating a current flow through charging cable 10.
(G) charging cable 10 as defined in point (F), the at least one switch unit 18 being suitable for de-energizing the current flow through charging cable 10 as a function of a fault current monitoring and temperature monitoring.
(H) charging cable 10 as defined in point (F), the at least one control unit 17 being suitable for regulating the maximum current intensity to be withdrawn for charging energy store 11.
(I) charging cable 10 as defined in point (A) or point (B) or point (C) or point (D) or point (E) or point (F) or point (G) or point (H), where communication unit 19 is suitable for being connected in a plugged-in state of charging cable 10 to a switchable power outlet 20 of energy supply unit 16 by charging cable 10 identifying power outlet 20 with the aid of communication unit 19, authorizing power outlet 20 and connecting through a current 21 for charging cable 10 in power outlet 20.

1-14. (canceled)

15. A charging cable for electrically connecting an energy store to be charged of a hybrid vehicle or electric vehicle to an energy supply unit providing electrical energy, the charging cable comprising:
a charging line including a coupling and multiple electrical conductors electrically connected to the coupling for power transfer and/or signal transfer;
a first connection device including an energy transfer arrangement configured for indirectly or directly detachable wireless and/or wired electrical connection to the energy store, the energy transfer arrangement including contacts or induction coils;
a second connection device including a first connection configured for indirectly or directly detachable wireless and/or wired electrical connection to the energy supply unit and to a second connection for detachable electrical connection to the coupling;
wherein respectively one electrical conductor of the electrical conductor of the charging line being assigned to each of the contacts or induction coils;
wherein the first connection device includes a control unit;
wherein the first connection device or the charging line include a bypass switch, the bypass switch being switchable between a first switching state and a second switching state as a function of a type of the second connection device, wherein: (i) in the first switching state, an electrical connection is established by the bypass switch between at least one of the contacts or induction coils and the assigned electrical conductor, while bypassing the control unit, and (ii) in the second switching state, the control unit is electrically interconnected between the at least of the contacts or induction coils, which is connected in the first switching state via the bypass switch to the assigned electrical conductor and the respectively assigned electrical conductor, to control a charging process.

16. The charging cable as recited in claim 15, wherein:
the charging line including an additional coupling,
the electrical conductors extend continuously between the coupling and the additional coupling for power transfer and/or signal transfer, and
the first connection device includes an additional connection, which is electrically connectable to the additional coupling to establish an electrical connection of the energy transfer arrangement and/or of the control unit and/or of the bypass switch to the electrical conductors of the charging line.

17. The charging cable as recited in claim 15, wherein:
the first connection device includes a first housing, at which:
both the energy transfer arrangement and the charging line are formed, or
both the energy transfer arrangement and the additional connection are formed; and/or
the second connection device includes a second housing, on which both the first connection and the second connection are formed.

18. The charging cable as recited in claim 15, wherein: (i) the bypass switch is switched in a presence of a supply voltage into the second switching state and into the first switching state in an absence of a supply voltage, and/or (ii) the bypass switch is switchable by the control unit between the first switching state and the second switching state.

19. The charging cable as recited in claim 18, wherein the second connection device includes a voltage supply, which is electrically coupled to the first connection and which provides an electrical supply voltage in the presence of an electrical voltage at the first connection, which may be applied, via the second connection and the charging line, to the bypass switch to switch the bypass switch into the second switching state.

20. The charging cable as recited in claim 15, wherein the second connection device includes a switch unit, via which an electrical connection between the energy supply unit and the second connection is activatable or deactivatable, the switch unit being controllable by the control unit, to control the charging process.

21. The charging cable as recited in claim 15, wherein the second connection device includes a continuous, constant, direct and uninterrupted electrical connection between the first connection and the second connection, without providing a supply voltage for the bypass switch and/or without passive or active electrical components.

22. The charging cable as recited in claim 15, wherein the first connection device includes: a communication unit including a radio communication interface, and/or a display module and/or input module for inputting a desired charge current intensity, and/or an energy measuring module configured to ascertain, an electrical energy that has flowed through the charging cable, and/or an authentication module configured for authenticating in the energy supply unit.

23. The charging cable as recited in claim 15, wherein the second connection device includes a temperature monitoring module, which is configured to: (i) output a temperature information signal to the control unit as a function of a temperature detected in the second connection device, and/or (ii) adjust and/or interrupt a current flow through the second connection device to maintain a predefined temperature range.

24. The charging cable as recited in claim 23, wherein the temperature monitoring module includes an evaluation circuit, which is connected to at least one temperature sensor situated in the second connection device, the evaluation circuit providing a status signal, as a function of an ascertained temperature, which is transmitted via an electrical conductor to the control unit, so that power input from the energy supply unit is reduced or interrupted using the control unit as a function of the status signal.

25. The charging cable as recited in claim 15, wherein the bypass switch is situated in: (i) the first connection device, or the coupling of the charging line, or an additional coupling of the charging line, the additional coupling being configured to be coupled to an additional coupling of the first connection device.

26. The charging cable as recited in claim 15, wherein the charging line extends continuously between the first connection device and the coupling, the charging line being attached non-detachably at the first connection device, and the charging line is fed all the way into a housing of the first connection device.

27. A connection device configured for use as first connection device in a charging cable, the connection device comprising:
an energy transfer arrangement including contacts or induction coils, for indirectly or directly detachable wireless and/or wired electrical connection to an energy store of a hybrid vehicle or electric vehicle;
a charging line or an additional coupling or electrical connection to a charging line;
a control unit; and
a bypass switch;
wherein respectively one electrical conductor is assigned to each of the contacts or induction coils;
wherein the bypass switch is switchable between a first switching state and a second switching state as a function of a type of a second connection device of the charging cable, an electrical connection being established by the bypass switch in the first switching state between at least one of the contacts or induction coils and the assigned electrical conductor while bypassing the control unit, and the control unit being electrically interconnected in the second switching state between the at least one of the contacts or induction coils, which is connected in the first switching state via the bypass switch to the assigned electrical conductor and the respectively assigned electrical conductor, to control a charging process.

28. A connection device configured for use as second connection device of a charging cable, the connection device comprising:
a first connection for indirectly or directly detachable wired and/or wireless electrical connection to an energy supply unit;
a second connection for indirectly or directly detachable wired and/or wireless electrical connection to a charging line of the charging cable;
a voltage supply which is electrically coupled to the first connection and which provides an electrical supply voltage in a presence of an electrical voltage at the first connection, which may be output to the charging line via the second connection; and
a switch unit, via which an output of an electrical voltage provided by the energy supply unit to the second connection is activatable or deactivatable, the switch unit being activatable via the second connection.
